(19) United States
(12) Patent Application Publication
(10) Pub. No.: US 2024/0420703 A1
(43) Pub. Date: Dec. 19, 2024

(54) Intelligent Dynamic Bit-Rate Rate Adjustment to Enhance Bluetooth Headset Performance

(71) Applicant: Google LLC, Mountain View, CA (US)

(72) Inventors: Xuemei Ouyang, Mountain View, CA (US); Daniel Jose Fernandes Barros, Mountain View, CA (US); Dennis Gee-Wai Yee, Mountain View, CA (US); Ya-ping Kuo, Mountain View, CA (US); Yungtsung Chen, Mountain View, CA (US); Po-wei Yeh, Mountain View, CA (US)

(73) Assignee: Google LLC, Mountain View, CA (US)

(21) Appl. No.: 18/700,624

(22) PCT Filed: Oct. 12, 2021
(86) PCT No.: PCT/US2021/054503

§ 371 Date: Apr. 11, 2024

(51) Int. Cl. G10L 19/002

(52) U.S. Cl. CPC G10L 19/002

(57) ABSTRACT

The present disclosure provides systems and methods for dynamically adjusting a bit-rate of encoded audio data. A buffer may receive audio data encoded at a first bit-rate. An audio data level corresponding to the amount of audio data stored within the buffer may be determined. The audio data level of the buffer may be determined to be within a buffer zone, and a bit-rate adjustment may be initiated after determining the audio data level is within a buffer zone.

### BACKGROUND

Wireless headphones receive and playback audio data transmitted from a host device, such as a smartphone. When transmission conditions are poor, such that not all data is received by the headphones or data transmission is slow, an audio glitch may occur. An audio glitch may include stalled or skipped playback of the audio by the headphones. To minimize audio glitches, transmission techniques such as increasing the transmission power by the host device and beamforming the transmission signal towards the wireless headphones may be used. These transmission techniques may increase the signal quality between the wireless headphones and the host device, thereby increasing the amount of data that can be transmitted. However, these transmission techniques are typically limited by the wireless communication technology implemented in the host device. In that regard, some wireless communication technology may be incapable of altering transmission power and/or beamforming. Further, given the small form factor of many host devices, the benefits of these transmission techniques may be constrained.

Jitter buffers within the wireless headphones may also be used to reduce audio glitches. A jitter buffer may temporarily store audio data received from the host device and output the stored audio data for playback by the wireless headphones. The audio data stored in the jitter buffer may provide a playback cushion of a certain length of time should transmission conditions deteriorate between the host device and the headphones. For instance, the jitter buffer may store audio data received from a host device before playback by the wireless headphones begins. During playback of the audio, the jitter buffer may continue to receive the audio data from the host device while outputting the audio data received from the host device on a first-in first out (FIFO) basis. In the event the transmission conditions deteriorate between the host device and the wireless headphones such that audio data is no longer received, or received at a slower rate than being output by the jitter buffer, the jitter buffer may continue to output audio data until the jitter buffer is empty. When transmission conditions improve before the jitter buffer empties, the wireless headphones may continue to playback audio uninterrupted. However, if the transmission conditions do not improve, the jitter buffer may empty and an audio glitch may occur.

### BRIEF SUMMARY

The present disclosure provides methods, systems, and computer-readable mediums for dynamically adjusting a bit-rate of encoded audio data. One aspect of the disclosure is directed to a method. The method may include: receiving, at a buffer, audio data encoded at a first bit-rate; determining, by one or more processors, an audio data level within the buffer, wherein the audio data level is the amount of audio data stored within the buffer; determining, by the one or more processors, the audio data level of the buffer is within a buffer zone; and initiating, by the one or more processors, a bit-rate adjustment after determining the audio data level is within a buffer zone

In some examples, the buffer may be within an accessory, and the audio is received from a host device.

In some instances, the buffer zone may be a normal zone, monitor zone, or a switch zone.

In some examples, the bit-rate adjustment may be initiated in response to determining the audio data level is within the switch zone.

In some instances, when the audio data level is within the monitor zone, the method may further comprise: starting a timer; upon the timer reaching a predetermined time, determining the audio data level of the buffer has decreased; and initiating the bit-rate adjustment in response to determining the audio data level of the buffer has decreased.

In some instances, the bit-rate adjustment may be a bit-rate reduction.

In some examples, when the audio data level is within the monitor zone, the method may further comprise: starting a timer; upon the timer reaching a predetermined time, determining the audio data level of the buffer has remained constant; and restarting the timer in response to determining the audio data level has remained constant.

In some instances, when the audio data level is within the monitor zone, the method may further comprise: starting a timer; upon the timer reaching a predetermined time, determining the audio data level of the buffer has increased; determining the audio data level is within the normal zone; and in response to determining the audio data level is within the normal zone, initiating the bit-rate adjustment.

In some examples, the bit-rate adjustment may be a bit-rate increase.

In some instances, when the audio data level is within the monitor zone, the method may further comprise: starting a timer; upon the timer reaching a predetermined time, determining the audio data level of the buffer has increased; determining the audio data level is not within the normal zone; and in response to determining the audio data level is not within the normal zone, restarting the timer.

In some examples, the one or more processors may be within the accessory.

In some examples, the buffer may be within a host device, and the audio data may be transmitted from the host device to an accessory.

In some instances, the one or more processors may be within the host device.

Another aspect of the disclosure is directed to a system. The system may include a first accessory, including a buffer and one or more processors. The one or more processors may be configured to: determine an audio data level within the buffer, wherein the audio data level is the amount of audio data stored within the buffer; determine the audio data level of the buffer is within a buffer zone; and initiate a bit-rate adjustment after determining the audio data level is within a buffer zone.

In some examples, the buffer zone may be a normal zone, monitor zone, or a switch zone.

In some instances, the bit-rate adjustment may be initiated in response to determining the audio data level is within the switch zone.

In some examples, when the audio data level is within the monitor zone, the one or more processors may be further configured to: start a timer; upon the timer reaching a predetermined time, determine the audio data level of the buffer has decreased; and initiate the bit-rate adjustment in response to determining the audio data level of the buffer has decreased.

In some examples, the bit-rate adjustment may be a bit-rate reduction.

In some instances, when the audio data level is within the monitor zone, the one or more processors may be further configured to: start a timer; upon the timer reaching a predetermined time, determine the audio data level of the buffer has remained constant; and restart the timer in response to determining the audio data level has remained constant.

In some examples, when the audio data level is within the monitor zone, the one or more processors may be further configured to: start a timer; upon the timer reaching a predetermined period of time, determine the audio data level of the buffer has increased; determine the audio data level is within the normal zone; and in response to determining the audio data level is within the normal zone, initiate the bit-rate adjustment.

### BRIEF DESCRIPTION OF THE DRAWINGS

FIG. 1 is a pictorial diagram of an example system according to aspects of the disclosure.

FIG. 2 is a functional block diagram of an example system according to aspects of the disclosure.

FIG. 3 is another functional block diagram of an example system according to aspects of the disclosure.

FIG. 4 is an illustration of a buffer within an accessory according to aspects of the disclosure.

FIG. 5 is a flow diagram illustrating a process for changing the bit-rate for encoding audio data based on the content level within a buffer of an accessory according to aspects of the disclosure.

FIG. 6 is a flow diagram illustrating a process for changing the bit-rate for encoding audio data based on the content level within a buffer of a host device according to aspects of the disclosure.

FIG. 7 is an illustration of a buffer within a host device according to aspects of the disclosure.

FIG. 8 is a flow diagram illustrating a method of adjusting the bit-rate for encoding audio data based on the operating parameters of the connection between an accessory and a host device according to aspects of the disclosure.

### DETAILED DESCRIPTION

### Overview

The technology described herein is directed to dynamically adjusting the bit-rate of audio data transmitted by a host device to an accessory based on detected or inferred buffer levels to minimize the possibility of an audio glitch occurring during playback of the audio. In general, audio content is encoded at particular bit-rates before transmission by a host device to an accessory device, such as a pair of Bluetooth headphones. For example, an audio file may be encoded at 320 kbps, 256 kbps, 128 kbps, 96 kbps, 64 kbps, or other such bit-rate. In some instances, audio files may be encoded at a variable rate. For instance, the bit-rate of audio files encoded using Advanced Audio Coding (AAC) Variable Bit-Rate (VBR) may change dynamically based on the content of the audio file. The larger the bit-rate audio file is encoded, the larger the size of the resulting audio data typically is. For instance, a 3 minute audio file encoded at a bit-rate of 256 kbps may be 5.76 MB, whereas the same 3 minute audio file encoded at a bit-rate of 128 kbps may be 2.88 MB. Thus, wirelessly transmitting an audio file generally requires the transmission of more audio data when the audio file is encoded at a higher bit-rate than when the audio file is encoded at a lower bit-rate. For instance, it may take more audio data to transmit an audio file encoded at 256 kbps than if the audio file were encoded at 128 kbps. Higher bit-rates may be desirable, as audio files encoded at higher bit-rates may provide better audio quality than if encoded at a lower bit-rate.

The amount of data that can be transmitted between a host device and accessory, including audio data, control data, and other such data, may be dependent on the hardware available in the host device and the accessory, the protocols supported by the host device and accessory, and the strength of the connection between the host device and the accessory. With regard to audio data transmission over Bluetooth, the Bluetooth hardware in the host device and accessory may be capable or otherwise configured to handle audio data encoded at particular bit-rates and in particular formats or codecs. For instance, the Bluetooth hardware may be configured to transmit audio using Advanced Audio Distribution Profile (“A2DP”) streaming protocol or other such protocols. However, each piece of Bluetooth hardware (e.g., host devices and accessories) may be capable of encoding and/or decoding data at certain bit-rates. In some instances, a host device may be capable of encoding data at more or fewer bit-rates than an accessory may be capable of decoding. However, to assure the accessory can properly decode the data, the host device should encode data at bit-rates that the accessory can decode. Further, some Bluetooth hardware may not be capable of timely transmitting and/or the amount of data necessary to playback an audio file encoded at a higher bit-rate. In these cases, other bit-rates may be used to encode audio data.

Even when both the host device and accessory are capable of encoding, decoding, and transmitting large amounts of audio data, the strength of the connection between the devices may limit the amount of audio data that can be transferred. Connection strength may be measured using a received signal strength indicator (RSSI), received signal power, and/or other such measures. Typically, the stronger the connection strength between the devices, the more reliable the delivery of audio data. Weaker connection strengths may lead to data loss, dropped packets (portions of audio data), signal dropouts, and other such issues, which may slow or otherwise prevent data transfer over the wireless connection.

To minimize the chances of an audio glitch occurring, an accessory or host device may monitor the audio data level of a buffer, such as a jitter buffer in the accessory. The jitter buffer of the accessory may temporarily store audio data received from the host device and output the stored audio data for playback. During playback of the audio, the jitter buffer may continue to receive the audio data from the host device while outputting the audio data received from the host device on a first in first out (FIFO) basis. In the event the transmission conditions deteriorate between the host device and the accessory such that the accessory no longer receives audio data, or the audio data is received at a slower rate than being output by the jitter buffer, the jitter buffer may continue to output audio data until the jitter buffer is empty. If the jitter buffer empties, an audio glitch may occur.

To mitigate the possibility of the jitter buffer emptying, when the amount of audio data within the buffer falls below a particular level or continues to fall over a particular time period, the bit-rate of the audio data encoded and transmitted by the host device may be reduced. Reducing the bit-rate of the encoded audio data may decrease the amount of audio data required to transmit an audio file for playback to the accessory. Thus, the amount of audio data in the data packets transmitted from the host device to the accessory is reduced. The smaller data packets may be more quickly and/or reliably transmitted from the host device to the accessory than is possible with the larger data packets over the same connection. As such, reducing the bit-rate of the encoded audio data may increase the possibility of the level of audio data in the jitter buffer remaining consistent or increasing. By maintaining or increasing the amount of audio data in the jitter buffer, the possibility of an audio glitch occurring due to an empty jitter buffer may be reduced.

In instances where encoding of audio data is performed by a separate hardware encoder, such as an encoder in digital signal processing (DSP) ASIC, the audio data level of a buffer on the host device may be monitored. Offloading of the encoding process to the DSP ASIC is referred to herein as “A2DP offloading.” For example, the buffer in the host device, such as a buffer in the Bluetooth controller that transmits the audio data to the accessory, may be monitored. The buffer in the Bluetooth controller may receive and temporarily store the encoded audio data received from the A2DP component. When the amount of audio data within the buffer of the Bluetooth controller goes above a particular level or continues to increase over a particular time period, the bit-rate of the audio data transmitted by the host device may be reduced. In this regard, when the audio data is being successfully transmitted by the host device to the accessory, the amount of data in the buffer of the Bluetooth controller should be low or empty. A low or empty buffer implies that the audio data is being adequately transmitted to the accessory. Increases to the amount of audio data within the buffer of the Bluetooth controller may indicate audio data transmission problems, which could lead to audio glitches during playback of the audio by the accessory. By reducing the bit-rate of the audio data encoded by the A2DP component, the packet size required to transmit an audio frame is reduced. As such, the airtime needed to transmit the packet is shorter, thereby providing a greater chance for the packet to be transmitted within a fixed time period. In this regard, packet transmission may be more successful when the packet size is reduced relative to a larger size packet, as less audio data is required to be transmitted over the fixed time period than when a larger packet size is used.

In instances where encoding of audio data is not offloaded to an A2DP component, the buffer in the host stack of the host device may be monitored. Like monitoring the buffer in the Bluetooth controller, as described herein, when the amount of audio data within the buffer of the host stack goes above a particular level or continues to increase over a particular time period, the bit-rate of the audio data transmitted by the host device may be reduced. In this regard, when the audio data is being successfully transmitted by the host device to the accessory, the amount of data in the buffer of the host stack should be low or empty. Thus, by reducing the bit-rate of the audio data encoded by the host device, the packet size required to transmit an audio frame is reduced. As such, the airtime needed to transmit the packet is shorter, thereby providing a greater chance for the packet to be transmitted within a fixed time period.

In yet another example, the jitter buffer level of the accessory may be inferred based on the operating parameters of the connection between the accessory and the host device. In this regard, it may be difficult to monitor the buffer size on the host device to know the state of the buffer on the accessory. In such a situation, and as described further herein, the RSSI value of the connection and the no reception (NoRx) and not acknowledged (NAK) count of data packet transmissions on the host device, such as a mobile phone, may be used to indicate the status of the buffer level of the accessory. Based on the inferred status of the buffer level of the accessory, the bit-rate of the audio data may be increased or reduced.

### Example Systems

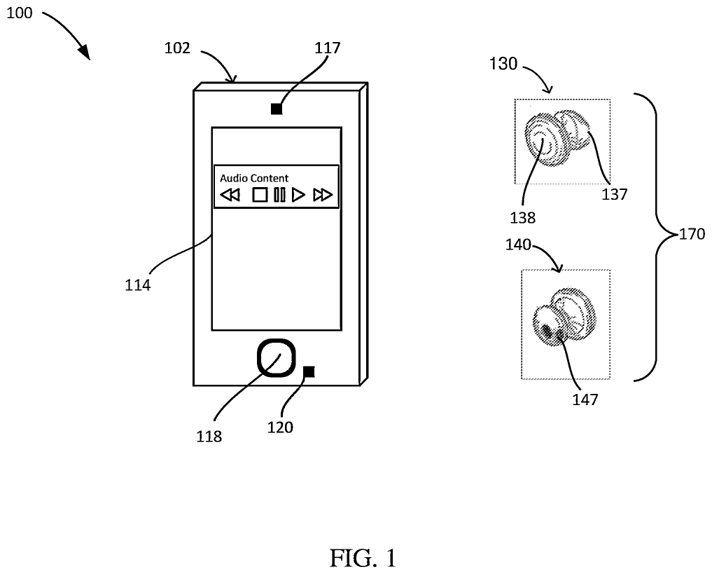

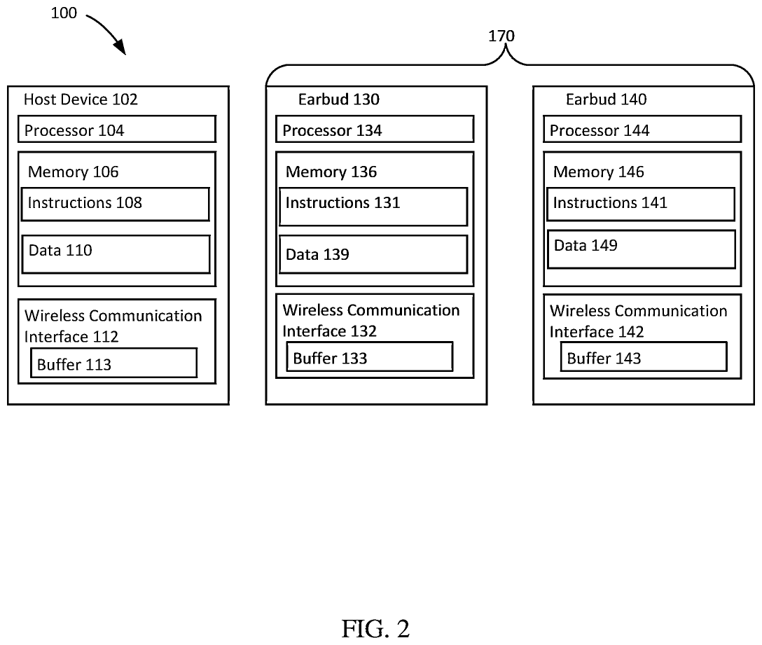

FIGS. 1 and 2 illustrate an example system 100 in which the features described herein may be implemented. It should not be considered limiting the scope of the disclosure or usefulness of the features described herein. In this example, system 100 includes a host device 102 and an accessory 170. The host device 102 is shown as a smartphone, and accessory 170 is shown as a pair of truly wireless earbuds 130, 140. The host device 102 may alternatively be any device capable of wirelessly communicating with an accessory, such as a mobile phone, personal computer, audio/video streaming device, netbook, wearable computing devices (e.g., smartwatch, smart glasses), gaming console, home assistant, etc. Accessory 170 may alternatively be any device capable of wirelessly receiving and playing back or outputting audio, such as a wireless headset, wireless earbuds (e.g., earbuds connected together but configured to receive audio wirelessly,) mobile phone, tablet PC, a netbook, wearable computing devices (e.g., a smart watch with a speaker, smart glasses with a speaker, virtual reality player with a speaker, other head-mounted displays with a speaker, etc.), wireless speakers, home assistants, gaming consoles, etc.

Host device 102 and/or earbuds 130, 140 may be a personal computing device intended for use having some or all of the components normally used in connection with a personal computing device, as described herein, including a one or more processors (e.g., a central processing unit (CPU)), memory (e.g., RAM and internal hard drives) storing data and instructions, a display 114 (e.g., a monitor having a screen, a touch-screen, a projector, a television, or other devices such as a smartwatch display that is operable to display information), an output (e.g. speakers 117, 137, 147), and user input devices (e.g., touchpad 118, 138, keyboard, touchscreen or microphone 120).

As illustrated in FIG. 2, host device 102 may contain one or more processors 104, memory 106 storing instructions 108 and data 110, a wireless communication interface 112, and buffer 113. The host device 102 may be able to communicate with accessory 170 via the wireless communication interface 112.

The one or more processors 104 may be any conventional processors, such as commercially available microprocessors. Alternatively, the one or more processors may be a dedicated device such as an application specific integrated circuit (ASIC) or other hardware-based processor.

Memory 106 may store information that is accessible by the processors, including instructions 108 and data 110. The memory 106 may be a type of memory operative to store information (e.g., data 110, instructions 108, etc.) accessible by the processors 104, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. The subject matter disclosed herein may include different combinations of the foregoing, whereby different portions of the instructions 108 and data 110 are stored on different types of media.

Data 110 may be retrieved, stored, or modified by processors 104 in accordance with the instructions 108. For instance, although the present disclosure is not limited by a particular data structure, the data 110 may be stored in computer registers, in a relational database as a table having a plurality of different fields and records, XML documents, or flat files. The data 108 may also be formatted in a computer-readable format such as, but not limited to, binary values, ASCII or Unicode. Moreover, the data 110 may comprise information sufficient to identify the relevant information, such as numbers, descriptive text, proprietary codes, pointers, references to data stored in other memories (including other network locations) or information that is used by a function to calculate the relevant data.

The instructions 108 can be any set of instructions to be executed directly, such as machine code, or indirectly, such as scripts, by the processor 104. In that regard, the terms “instructions,” “applications,” “steps,” and “programs” can be used interchangeably herein. The instructions can be stored in object code format for direct processing by the processor, or in any other computing device language, including scripts or collections of independent source code modules that are interpreted on demand or compiled in advance. Functions, methods, and routines of the instructions are explained in more detail below.

The host device 102 may further include a wireless communication interface 112, such as an antenna, transceiver, and any other devices used for wireless communication. The antenna may be, for example, a short-range wireless network antenna. The host device 102 may be coupled with accessory 170, including earbuds 130 and 140 via a wireless connection. For instance, the wireless communication interface 112 may be a Bluetooth controller configured to transmit and receive Bluetooth signals. As further shown in FIG. 2, wireless communication interface 112 may include an internal buffer 113, such as a jitter buffer. The buffer may store data, such as audio data. The data in buffer 113 may be transmitted by the wireless communication interface 112 to one or more accessories, such as earbuds 130, 140.

Although FIG. 2 functionally illustrates the processor 104, memory 106, and other elements of host device 102 as being within the same block, it will be understood that the processor, memory, and other elements of the host device 102 may include multiple processors, memory, and/or other components, that may or may not be stored within the same physical housing. Similarly, the memory may be a hard drive or other storage media located in a housing different from host device 102. Accordingly, references to a processor or computing device will be understood to include references to a collection of processors or computing devices that may or may not operate in parallel.

Accessories may each include one or more processors, memory, and wireless communication interfaces that are substantially similar to those described herein with respect to host device 102. For instance, earbud 130 includes processor 134, memory 136, and wireless communication interface 132, including internal buffer 133. Earbud 140 includes processor 144, memory 146, and wireless communication interface 142, including internal buffer 143. Wireless communication interfaces 132, 142 may be Bluetooth controllers capable of communication with wireless communication interface 112 of the host device. Although buffers 133 and 143 are shown as being within wireless communication interfaces, the buffers may be elsewhere within the accessory. For instance, buffer 133 may be in memory 136 or some other memory of earbud 130.

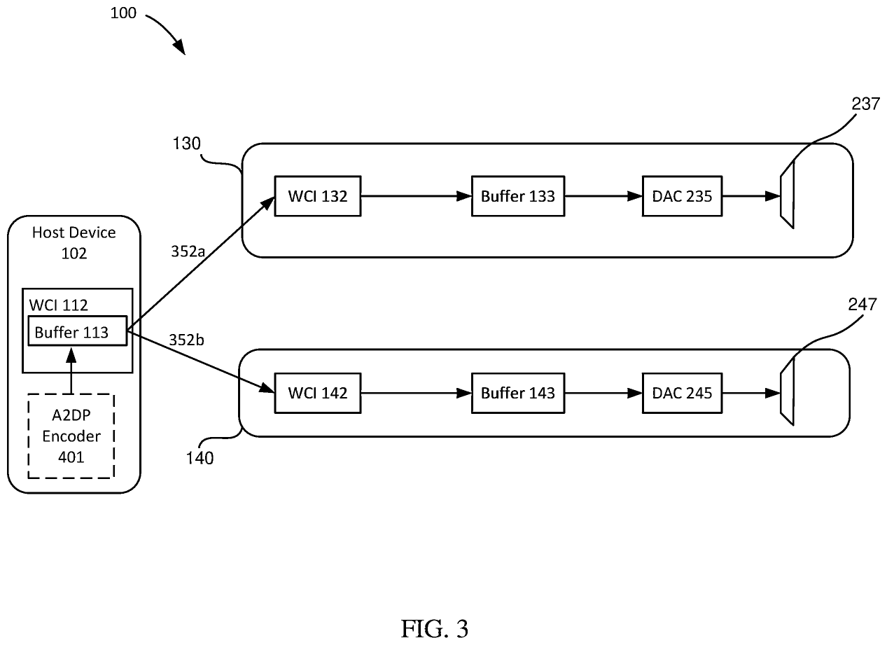

The internal buffer of the accessory, including internal buffers 133, 143 of the earbuds 130, 140, respectively, may store data, such as audio data received from the host device 102. For example, FIG. 3 illustrates host device 102 transmitting audio data, such as audio content (also referred to herein as an “audio file”), via signal 352a to earbud 130 and via signal 352b to earbud 140 of system 100. In this regard, the wireless communication interface 112 may transmit signal 352a to wireless communication interface 132 and signal 352b to wireless communication interface 142. Before transmission, the wireless communication interface 112 may wrap the audio data into packets. Then, the individual packets may be transmitted over signals 352a and 352b.

Signal 352a may be received by wireless communication interface 132, and signal 352b may be received by wireless communication interface 142. Wireless communication interface 132 may store audio data received from signal 352a within internal buffer 133. Wireless communication interface 142 may store audio data received from signal 352b within internal buffer 143. The audio data received from signals 352a and 352b may be unwrapped from their respective packets before or after placement within the internal buffer 133 and 143. Although FIG. 3 illustrates internal buffers 133, 143 as outside of wireless communication interfaces 132, 142, respectively, the internal buffers 133, 143 may be within wireless communication interfaces 132, 142. The audio data within buffer 133 may be processed by digital-to-analog converter (DAC) 235 for playback by speaker 237. Likewise, the audio data within buffer 143 may be processed by DAC 245 for playback by speaker 247.

As further illustrated in FIG. 3, the host device may include an A2DP encoder 401. The A2DP encoder 401 may be configured to encode the audio content at certain bit-rates before the audio content is placed in buffer 113 of the wireless communication interface 112.

The amount of data that can be transmitted between wireless communication interfaces, such as wireless communication interface 112 and wireless communication interfaces 132, 142, may depend on the strength of the connection. As previously described, connection strength may be measured using a received signal strength indicator (RSSI), received signal power, and/or other such measures. Stronger connections may provide more reliable delivery of data, such as data packets. Conversely, weaker connections may lead to data loss, dropped packets, signal dropouts, and other issues, which may slow or otherwise prevent data transfer over the wireless connection.

In some instances, accessories 130, 140 may be able to receive and/or transmit content to each other. For example, host device 102 may stream audio data to only one of the wireless communication interfaces of the accessories. For example, the wireless communication interface 112 may transmit a signal including audio data corresponding to a stereo audio file configured for playback by two speakers to the wireless communication interface 132 of accessory 130. The wireless communication interface 132, or some other component of accessory 130, such as processor 134, may parse the audio data into left channel data and right channel data. Depending on whether the accessory 130 is a left earbud or a right earbud, the accessory may transmit the left channel or right channel data to accessory 140. For instance, if accessory 130 is a left earbud, accessory 130 may playback the left channel data through the speaker 237 and transmit the right audio channel to accessory 140 via wireless communication interface 132. Accessory 140 receives and playback the right audio channel data through speaker 247.

### Example Methods

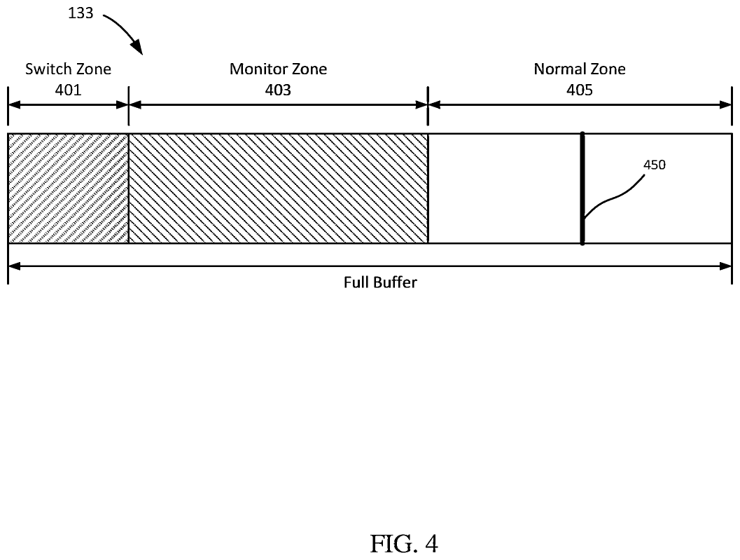

As described herein, the bit-rate of audio data transmitted by the host device to an accessory may be dynamically adjusted based on detected or inferred buffer levels to minimize the possibility of an audio glitch occurring. FIG. 4 illustrates buffer 133 of earbud 130. When the earbud 130 is to playback audio, the host device, such as host device 102, may transmit audio data to the earbud 130. The audio content may be temporarily stored within buffer 133. The earbud 130 may not begin playing back audio data from buffer 133 until the amount of audio data in buffer 133 reaches a watermark level, illustrated by line 450 within normal zone 405. Once the level of audio data in buffer 133 reaches the watermark level 450, the content stored in buffer 133 may be output for playback on a first in first out (FIFO) basis. Simultaneously, buffer 130 may continue to temporarily store the audio data transmitted from the host device 102.

When transmission of the audio content from the host device to the earbud is going well, the level of audio data in buffer 133 should be close to the watermark 450. In this regard, when the level of audio data in the buffer is in the normal zone 405, where the watermark 450 is, the level of audio data in the buffer is high. This high level of audio data in buffer 133 provides a playback cushion should transmission conditions deteriorate between the host device and the earbud. If transmission conditions deteriorate between the host device 102 and the earbud 130, the level of audio data within the buffer may be reduced and move into the monitor zone 403, and, in some instances, into switch zone 401. In order to minimize the risk of an audio glitch occurring during playback of the audio, the audio data level of buffer 133 should be maintained in normal zone 405. In instances where the audio data level of the buffer falls into the switch zone or monitor zone, the bit-rate of the audio data transmitted by the host device 102 to the earbud 130 may be reduced.

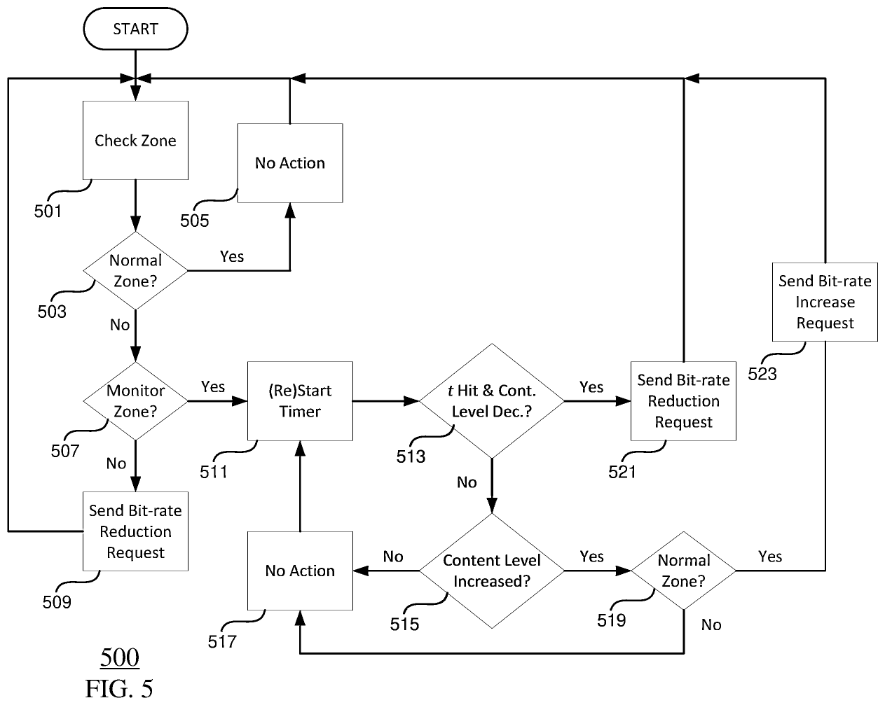

FIG. 5 illustrates a flow chart 500 illustrating a process for determining when to decrease and increase the bit-rate of the audio data transmitted by the host device. The steps shown in FIG. 5 may be performed by a processor, such as processor 134 of earbud 130. As shown in block 501, the zone in which the audio data level of buffer 133 may be identified. Initially, the process may determine if the audio level is in the normal zone, as shown in block 503. If the audio data level of the buffer is in the normal zone, no action may be taken, as shown in block 505. The process 500 may then move back to the start.

If the audio data level of buffer 133 is not in the normal zone, a determination as to whether the audio data level of buffer 133 is in the monitor zone may be made, as shown in block 507. A determination that the audio data level of buffer 133 is not in the monitor zone, as determined by the processor 134 in block 507, or the normal zone as determined by the processor 134 in block 503, indicates that the audio data level of buffer 133 is within the switch zone. When the audio data level of buffer 133 is determined to be in the switch zone, a bit-rate reduction request may be sent from the accessory to the host device, as shown in block 509. The bit-rate reduction request may be sent by processor 134 to the host device via wireless communication interface 132. Process 500 may then move back to the start.

If the audio data level of buffer 133 is determined to be in the monitor zone at step 507, a timer may be started, as shown in block 511. Once the timer reaches time t, an updated determination of the audio data level of buffer 133 may be made, as illustrated in block 513. Time may be 0.5 seconds, 1 second, or more or less. If the audio data level of buffer 133 has decreased since the start of the timer to time t, a bit-rate reduction request may be sent to the host device, as shown in block 521. In some instances, a bit-rate reduction request may be sent at block 521 only if the audio data level of buffer 133 has dropped by a predetermined amount between the start of the timer until time t.

If the audio data level of buffer 133 has not decreased, as determined at step 513, the audio data level may be reviewed to determine if it has increased or remained consistent from the beginning of the timer to time t, as shown at block 515. If the audio data level of buffer 133 has remained constant, then no action may be taken, as shown in block 517. The processes may then proceed to block 511, where the timer may be restarted.

When the audio data level of buffer 133 has increased, the process may move to block 519. At block 519 a determination of whether the audio data level of buffer 133 has moved back into the normal zone may be made. When the audio content level of buffer 133 has not moved out of the monitor zone, the process may progress to block 517, where no action is taken. The timer may then subsequently be restarted, as further illustrated in block 511. Although block 511 describes restarting the timer, the current time may be considered the “beginning of the timer.”

When the audio content level of buffer 133 has moved into the normal zone, a bit-rate increase request may be sent to the host device, as shown in block 523. In some instances, the bit-rate increase request may be sent at block 523 only if the audio content level of buffer 133 is above a certain threshold level. The process may then move back to the start. Process 500 may occur continually or at predefined intervals, such as every 500 ms, or more or less.

Although the above description of process 500 describes monitoring the audio data level of buffer 133 by processor 134, the buffer of any accessory may be monitored. For instance, buffer 143 may be monitored by processor 144 of earbud 140. In the case of an accessory with multiple buffers, such as accessory 170 with earbud 130 having buffer 133 and earbud 140 having buffer 143, both buffers may be monitored. The bit-rate of the encoded audio data may be based on the lowest-performing of the buffers. For instance, if the audio content level of buffer 133 is in the normal zone, but the audio content level of buffer 143 is in the switch zone, the host device 102 may reduce the bit-rate in response to the bit-rate reduction request received from earbud 140. Thus, both earbuds 130, 140 will receive audio content encoded at the reduced bit-rate to minimize the risk of an audio glitch occurring at earbud 140.

To communicate bit-rate change requests, such as shown in blocks 509, 521, and 523 in process 500 of FIG. 5, the host device and the accessory may use a set of shared protocols. However, given the large number of manufacturers and vendors of accessories and host devices, it may be difficult to assure each accessory and host device include the set of shared protocols. When the accessory or host device does not have or is not configured to use the protocols, communicating bit-rate change requests may not be possible. The host device may implement the control of bit-rate changes to avoid the need for the shared protocols.

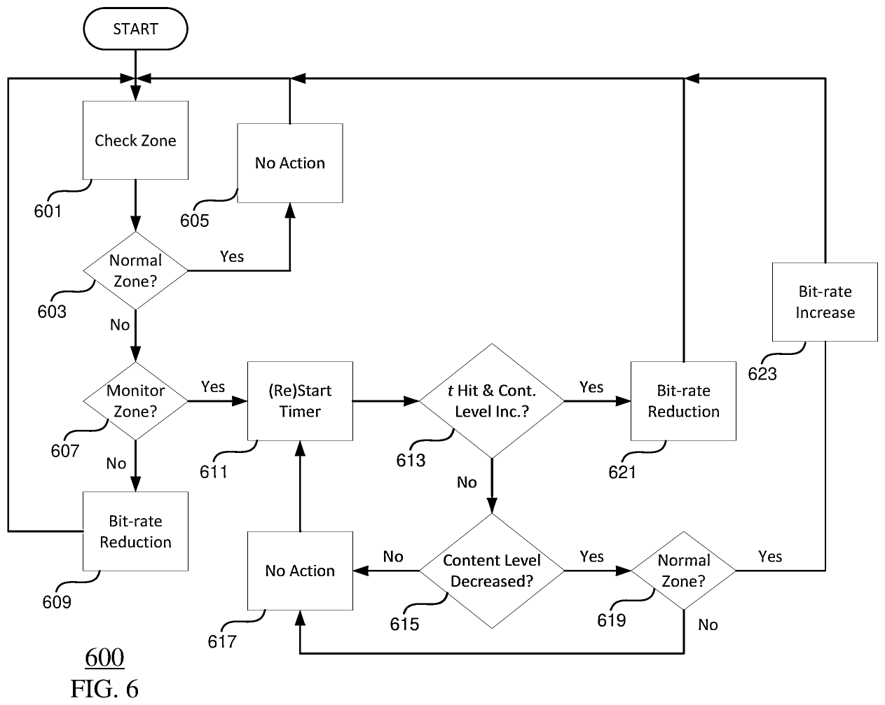

For example. FIG. 6 illustrates a flow chart 600 illustrating a process for determining when to decrease and increase the bit-rate of the audio data transmitted by a host device, such as host device 102, by monitoring a buffer of the host device, such as buffer 113. The steps shown in FIG. 6 may be performed by a processor, such as processor 104 of host device 102. As shown in block 601, the zone in which the audio data level of buffer 113 may be identified.

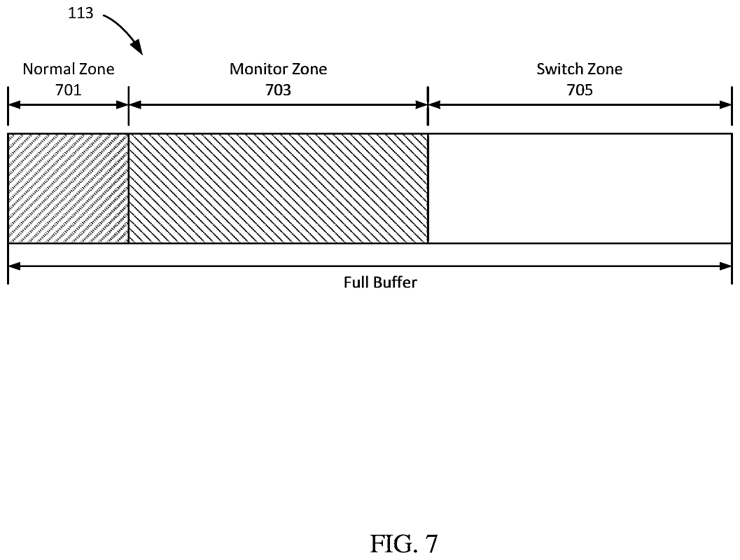

FIG. 7 illustrates buffer 113 of host device 102. When the host device 102 is transmitting audio content for playback at an accessory, audio data, such as data received from an A2DP component, may be temporarily stored within buffer 113 before transmission. When transmission of the audio content from the host device to the accessory is going well, the level of audio data in buffer 113 should be within normal zone 701. Normal zone 701 indicates that little to no audio data is within buffer 113. In this regard, when the transmission of audio content is going well, the audio data should move quickly into and out of the buffer 113, without a buildup of audio data within the buffer.

If transmission conditions deteriorate between the host device 102 and the accessory, the level of audio data within the buffer may be increased and move into the monitor zone 703, and, in some instances, into switch zone 705. To minimize the risk of an audio glitch occurring during playback of the audio by the accessory, the audio data level of buffer 113 should be maintained in normal zone 701. In instances where the audio data level of the buffer falls into the switch zone or monitor zone, the bit-rate of the audio data transmitted by the host device 102 to the accessory may be reduced. Bit-rate increases and decreases may be made by the A2DP encoder 104. In this regard, processor 104 of host device 102 may communicate with the A2DP Encoder 401 to trigger bit-rate increases and bit-rate decreases.

Initially, process 600 may determine if the audio level is in the normal zone, as shown in block 603. If the audio data level of the buffer is in the normal zone, no action may be taken, as shown in block 605. The process 600 may then move back to the start. If the audio data level of buffer 113 is not in the normal zone, a determination as to whether the audio data level of buffer 113 is in the monitor zone may be made, as shown in block 607. A determination that the audio data level of buffer 113 is not in the monitor zone, as determined by the processor 134 in block 607, or the normal zone as determined by the processor 134 in block 603, indicates that the audio data level of buffer 113 is within the switch zone. When the audio data level of buffer 113 is determined to be in the switch zone, a bit-rate reduction may be made by the host device, as shown in block 609. Process 600 may then move back to the start.

If the audio data level of buffer 113 is determined to be in the monitor zone at step 607, a timer may be started, as shown in block 611. Once the timer reaches time t, an updated determination of the audio data level of buffer 113 may be made, as illustrated in block 613. Time t may be 0.5 seconds, 1 second, 2 seconds, or more or less. If the audio data level of buffer 113 has increased since the start of the timer to time t, a bit-rate reduction may be made by the host device, as shown in block 621. In some instances, a bit-rate reduction may be made if the audio data level of buffer 113 has increased by a predetermined amount between the start of the timer until time t.

If the audio data level of buffer 113 has not increased, as determined at step 613, the audio data level may be reviewed to determine if it has decreased or remained constant from the beginning of the timer to time t, as shown at block 615. If the audio data level of buffer 113 has remained constant, then no action may be taken, as shown in block 617. The processes may then proceed to block 611, where the timer may be restarted.

When the audio data level of buffer 113 has decreased, the process may move to block 619. At block 619 a determination of whether the audio data level of buffer 113 has moved back into the normal zone may be made. When the audio content level of buffer 113 has not moved out of the monitor zone, the process may progress to block 617, where no action is taken. The timer may then subsequently be restarted, as further illustrated in block 611. Although block 611 describes restarting the timer, the current time may be considered the “beginning of the timer.”

When the audio content level of buffer 113 has moved into the normal zone, a bit-rate increase may be made by the host device, as shown in block 623. In some instances, the bit-rate increase may be made at block 623 only if the audio content level of buffer 113 is below a certain threshold level. The process may then move back to the start. Process 600 may occur continually or at predefined intervals, such as every 500 ms, or more or less.

In instances where the encoding of audio data is not offloaded to an A2DP component, such as A2DP encoder 104, the buffer in the host stack of the host device may be monitored. In this regard, although process 600 describes monitoring buffer 113, process 600 may be used to monitor the buffer of the host stack. As with monitoring buffer 113 in the Bluetooth controller, as described above with regard to process 600, when the amount of audio data within the buffer of the host stack goes above a particular level or continues to increase over a time period, the bit-rate of the audio data transmitted by the host device may be reduced. Bit-rate reductions and increases may be performed by a host device processor, such as processor 104.

As described above, each host stack architecture may be different. For instance, one host stack may have a buffer capable of holding relatively large amounts of audio data, such as 28 audio frames, or more or less, while other host stacks may have buffers that hold more or less audio content. Moreover, accessories generally have smaller buffer sizes. For instance, a wireless headset may only hold 5-10 audio frames. As such, it may be difficult to monitor the buffer size on the host stack and confidently know the risk level of an audio glitch occurring on the accessory side. To address this issue, the jitter buffer level of the accessory may be inferred based on the operating parameters of the connection between the accessory and the host device. For instance, on the host device, operating parameters including the RSSI value. NoRx and NAK count can be used to trigger bit-rate changes.

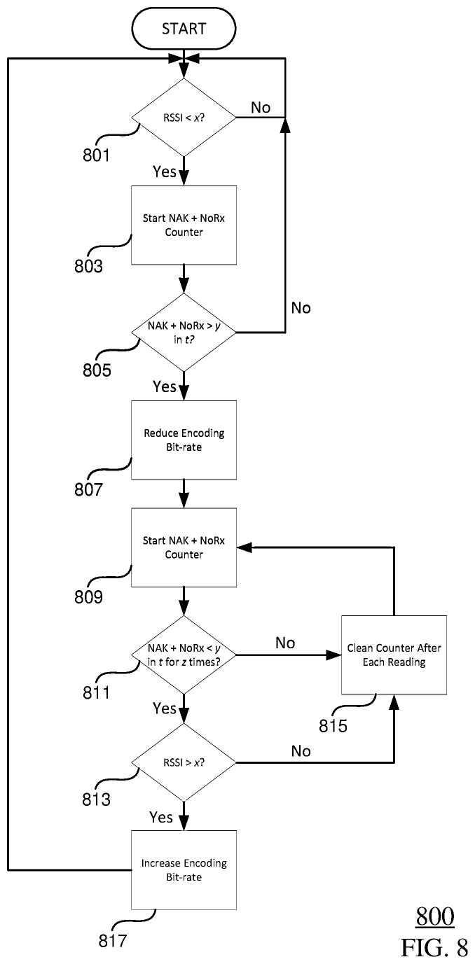

As outlined in process 800 of FIG. 8, the process conducts a check of the RSSI value, and then when the RSSI value indicates a weak connection, the process may monitor the NoRX and NAK count to determine if the bit-rate of the encoded audio should be changed. The NoRx and NAK count may be used to estimate buffer status on the accessory side. In this regard, there are two levels of NoRx and NAK counting depending on what number is, or can be, retrieved from the BT controller on the host side. In the first level, when the NoRx and NAK count for individual packets is unavailable, a statistic on all packets within a defined period may be used to estimate the audio data level of the buffer on the accessory side. As this statistic is an estimation based on all packets, the estimate may not be accurate. Thus, to minimize the risk of an audio glitch occurring, lowering the bit-rate of the encoded data may occur more aggressively. Further, returning to a higher bit-rate may occur more slowly.

In instances where the NoRx and NAK count for individual packets can be retrieved, a more accurate model may be used to estimate the audio data content level of the buffer in the accessory from the NoRx and NAK plus their respective timestamps, as described herein. This more accurate estimation can provide a more accurate indication of when bit-rate changes should occur. Thus, bit-rate reduction may be less aggressive.

At step 801 of process 800, the RSSI value of the connection between the host device and the accessory may be compared to a target value, x. x may be −80 dBm, or more or less. If the RSSI value is above the target value, no action may be taken, and process 800 may restart. If the RSSI value is below the target value, a NAK and NoRX counter may begin, as shown in block 803. The total count of NAK plus NoRx through a time period, t, may then be compared to a target value, y, as shown in block 805. Time/may be dependent upon the device buffer size. Target value y may be (buffer size/packet length)*75%. Although other target values may be used, such as a predefined target value. If the total count of NAK plus NoRx at the end of time period t is less than y, then no action may be taken, and process 800 may restart. However, if the total count of NAK plus NoRx over time period t is greater than y, a bit-rate reduction may be made by the host device, as shown in block 807.

After reducing the bit-rate in step 807, a new counter may be started for NAK and NoRX, as shown in block 809. The process 800 may then determine whether the total count of NAK plus NoRx is less than target value y over the time period t for a predetermined number of times z, as illustrated by block 811. The number of times z may be 2, 3, 4, or more or less. If the value of NAK plus NoRx is not less than y, the counter may be cleared, as shown in block 815, and the process 800 may move back to step 809. In the event the counter is less than y, as determined in block 811, the RSSI value of the connection between the host device and the accessory may again be compared to a target value, x, as shown in block 813. If the RSSI value is greater than the target value, the bit-rate may be increased, as shown at block 817. Otherwise, the counter may be cleared, as shown in block 815, and process 800 may move back to step 809. Process 800 may occur continually or at predefined intervals, such as every 500 ms, or more or less.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including,” and the like, should not be interpreted as limiting the subject matter of the claims to the specific examples; rather, the examples are intended to illustrate only one of many possible embodiments. Further, the same reference numbers in different drawings can identify the same or similar elements.

1. A method for dynamically adjusting a bit-rate of encoded audio data, the method comprising:
receiving, at a buffer, audio data encoded at a first bit-rate;
determining, by one or more processors, an audio data level within the buffer, wherein the audio data level is the amount of audio data stored within the buffer;
determining, by the one or more processors, the audio data level of the buffer is within a buffer zone; and
initiating, by the one or more processors, a bit-rate adjustment after determining the audio data level is within a buffer zone

2. The method of claim 1, wherein the buffer is within an accessory, and the audio is received from a host device.

3. The method of claim 2, wherein the buffer zone is a normal zone, monitor zone, or a switch zone.

4. The method of claim 3, wherein the bit-rate adjustment is initiated in response to determining the audio data level is within the switch zone.

5. The method of claim 3, wherein when the audio data level is within the monitor zone, the method further comprises:
starting a timer;
upon the timer reaching a predetermined time, determining the audio data level of the buffer has decreased; and
initiating the bit-rate adjustment in response to determining the audio data level of the buffer has decreased.

6. The method of claim 5, wherein the bit-rate adjustment is a bit-rate reduction.

7. The method of claim 3, wherein when the audio data level is within the monitor zone, the method further comprises:
starting a timer;
upon the timer reaching a predetermined time, determining the audio data level of the buffer has remained constant; and
restarting the timer in response to determining the audio data level has remained constant.

8. The method of claim 3, wherein when the audio data level is within the monitor zone, the method further comprises:
starting a timer;
upon the timer reaching a predetermined time, determining the audio data level of the buffer has increased;
determining the audio data level is within the normal zone; and
in response to determining the audio data level is within the normal zone, initiating the bit-rate adjustment.

9. The method of claim 8, wherein the bit-rate adjustment is a bit-rate increase.

10. The method of claim 3, wherein when the audio data level is within the monitor zone, the method further comprises:
starting a timer;
upon the timer reaching a predetermined time, determining the audio data level of the buffer has increased;
determining the audio data level is not within the normal zone; and
in response to determining the audio data level is not within the normal zone, restarting the timer.

11. The method of claim 2, wherein the one or more processors are within the accessory.

12. The method of claim 1, wherein the buffer is within a host device, and the audio data is transmitted from the host device to an accessory.

13. The method of claim 12, wherein the one or more processors are within the host device.

14. A system, comprising:
a first accessory, including a buffer and one or more processors, wherein the one or more processors are configured to:
determine an audio data level within the buffer, wherein the audio data level is the amount of audio data stored within the buffer;
determine the audio data level of the buffer is within a buffer zone; and
initiate a bit-rate adjustment after determining the audio data level is within a buffer zone

15. The system of claim 14, wherein the buffer zone is a normal zone, monitor zone, or a switch zone.

16. The system of claim 15, wherein the bit-rate adjustment is initiated in response to determining the audio data level is within the switch zone.

17. The system of claim 15, wherein when the audio data level is within the monitor zone, the one or more processors are further configured to:
start a timer;
upon the timer reaching a predetermined time, determine the audio data level of the buffer has decreased; and
initiate the bit-rate adjustment in response to determining the audio data level of the buffer has decreased.

18. The system of claim 17, wherein the bit-rate adjustment is a bit-rate reduction.

19. The system of claim 15, wherein when the audio data level is within the monitor zone, the one or more processors are further configured to:
start a timer;
upon the timer reaching a predetermined time, determine the audio data level of the buffer has remained constant; and
restart the timer in response to determining the audio data level has remained constant.

20. The system of claim 15, wherein when the audio data level is within the monitor zone, the one or more processors are further configured to:
start a timer;
upon the timer reaching a predetermined time, determine the audio data level of the buffer has increased;
determine the audio data level is within the normal zone; and
in response to determining the audio data level is within the normal zone, initiate the bit-rate adjustment.
